(19) United States
(12) Patent Application Publication
(10) Pub. No.: US 2020/0057989 A1
(43) Pub. Date: Feb. 20, 2020

(54) TEMPERATURE PACK COOLING SYSTEMS AND METHODS OF CONTROLLING PRODUCT TEMPERATURES DURING DELIVERY

(71) Applicant: Walmart Apollo, LLC, Bentonville, AR (US)

(72) Inventors: David C. Winkle, Bella Vista, AR (US); Brian G. McHale, Chadderton Oldham (GB); Donald R. High, Noel, MO (US); Sadaf Ali, Roanoke, TX (US); Todd D. Mattingly, Bentonville, AR (US)

(21) Appl. No.: 16/301,993

(22) PCT Filed: May 17, 2017
(86) PCT No.: PCT/US2017/033016

§ 371 Date: Nov. 15, 2018

Related U.S. Application Data
(60) Provisional application No. 62/338,246, filed on May 18, 2016.

(51) Int. Cl. G06Q 10/08; F25D 3/06

(52) U.S. Cl. CPC G06Q 10/0832; F25D 3/06

(57) ABSTRACT

In some embodiments, systems and methods are provided that limit the change in temperature and/or control a temperature of products during delivery. Some embodiments provide systems to limit temperature changes of products during transit, comprising: a plurality of insulation; a plurality of temperature packs; a product delivery control circuit that: obtains an identification of each of multiple products to be transported; obtains transport temperature thresholds corresponding one of the multiple products; obtains transport parameters comprising a predicted transport duration and expected environmental conditions; determines quantities of insulation to be positioned at each of multiple different insulation locations about the multiple products and number of temperature packs to be positioned at cooling locations about the multiple products; and determines an ordered arrangement of each of the multiple products relative to the temperature threshold of each of the multiple products, the insulation locations and the cooling locations.

### CROSS-REFERENCE TO RELATED APPLICATION

This application claims the benefit of U.S. Provisional Application No. 62/338,246, filed May 18, 2016, which is incorporated herein by reference in its entirety.

### TECHNICAL FIELD

This invention relates generally to product temperature control systems.

### BACKGROUND

In a modern retail environment, there is a need to improve the customer service and/or convenience for the customer. One aspect of customer service is the delivery of products. There are numerous ways to delivery products to customers. Getting the product to a delivery location, however, can adversely affect the product, can cause undesirable delays, can add cost and reduce revenue.

### BRIEF DESCRIPTION OF THE DRAWINGS

Disclosed herein are embodiments of systems, apparatuses and methods pertaining to product temperature control systems. This description includes drawings, wherein:

FIG. 1 illustrates a simplified block diagram of an exemplary product delivery coordinating system configured to coordinate and/or schedule delivery of products while limiting temperature changes and/or maintaining temperatures of one or more products while transported to one or more delivery locations, in accordance with some embodiments.

FIG. 2 illustrates an exemplary system for use in implementing methods, techniques, devices, apparatuses, systems, servers, sources and the like in limiting temperature changes of a product during transit, in accordance with some embodiments.

FIG. 3 illustrates a simplified block diagram cross-sectional view of a series of products arranged with a number of exemplary temperature packs and quantities of exemplary insulation of an exemplary temperature pack cooling system, in accordance with some embodiments.

FIG. 4 illustrates a simplified block diagram plane view of an exemplary flexible membrane insulator, in accordance with some embodiments.

FIG. 5 illustrates a simplified block diagram cross-sectional view of a series of products arranged with a number of exemplary temperature packs and cooperated with one of multiple flexible membrane insulators providing an exemplary temperature pack cooling system, in accordance with some embodiments.

FIG. 6 illustrates a simplified flow diagram of an exemplary process of limiting temperature changes of a product during transit, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein,

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful to limit changes in temperature of one or more products being transported to a delivery location. By limiting changes of temperature, products can be kept below or above threshold temperatures, maintain a freshness of products, and other such benefits. In some embodiments, the system identifies various delivery parameters in selecting a product cooling system, from multiple different available cooling systems, that is to be used in limiting temperature changes and/or maintaining temperatures of one or more products while the one or more products are transported to one or more delivery locations. The cooling systems can be implemented to provide temperature control of one or more products, typically a limited number of products, and without having to control the temperature of an entire delivery vehicle or large compartment of a delivery vehicle. Accordingly, the multiple product cooling systems can limit temperature variations and/or control temperatures specific to individual or limited numbers of products. Further, in some embodiments the cooling systems are configured to have a relatively small volume. In some implementations, the product temperature control systems (e.g., product cooling systems) can provide individual temperature control for a single product. Such individual temperature control allows individual products to be transported by some delivery methods while still maintaining desired temperature thresholds, and/or can transport one or more products that are to be maintained at different desired temperatures along with other products that do not require temperature control by the same delivery vehicle.

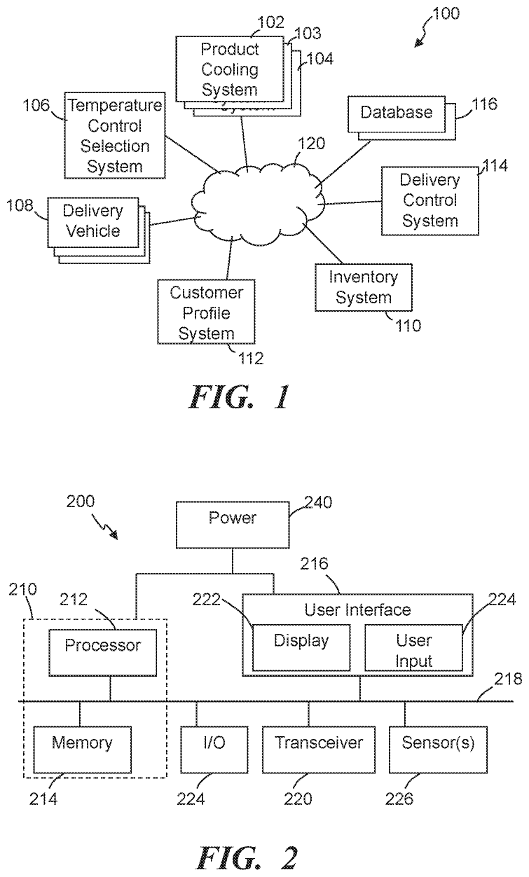

FIG. 1 illustrates a simplified block diagram of an exemplary delivery coordinating system 100 that is configured to coordinate and/or schedule delivery of products while limiting temperature changes and/or maintaining temperatures of one or more products while transported to one or more delivery locations, in accordance with some embodiments. The system 100 includes multiple different types of product cooling systems 102-104 and/or product heating systems, a temperature control selection system 106, and multiple different types of delivery vehicles 108. Some embodiments further include one or more inventory systems 110 associated with one or more retail facilities, customer profile system 112, delivery control system 114, and one or more databases 116 (e.g., one or more customer databases, inventory databases, product databases, route parameter databases, etc.). One or more computer and/or communication networks 120 establish communication connections between two or more of the components of the system 100 and allow communications and/or data transmissions between two or more of the components of the system 100. In some embodiments, the delivery coordinating system is associated with one or more retail facilities from which products can be purchased and/or that coordinates delivery of those products. The shopping facility may, in some instances, be a retail sales facility, a fulfillment center, a distribution center, or other type of facility in which products are sold and/or distributed to customers. The facility may be any size or format, and may include products from one or more merchants. For example, a facility may be a single store operated by one merchant, a chain of two or more stores operated by one entity, or may be a collection of stores covering multiple merchants. Further, in some applications the delivery control circuit 114 may be part of the temperature control selection system 106.

The temperature control selection system 106 utilizes product parameters and delivery parameters in evaluating which product cooling system and/or delivery vehicle are to be employed in transporting one or more products to one or more delivery locations. Typically, the temperature control selection system identifies products that have one or more temperature thresholds that are to be maintained and/or not to be exceeded. For example, a products may have one or more of a desired storage threshold temperature, a desired transport temperature, a regulatory or government specified temperature threshold, other such temperature thresholds, and in some instances a combination of two or more temperature thresholds. Further, some of the temperature thresholds may correspond to time thresholds, where for a particular product it may be desired that the product be maintained below a first temperature threshold, but can exceed the first temperature for less than a threshold duration of time and typically while being maintained under a second temperature threshold. One or more databases may be accessed (e.g., product database, inventory database, regulatory database, etc.) to obtain information about one or more temperature thresholds and/or corresponding duration thresholds.

Further, the temperature control selection system typically takes into consideration transportation parameters in selecting a product cooling system 102-104 to be used in transporting one or more products. The transport parameters can include, but are not limited to, expected duration of transport and/or duration of exposure to non-temperature controlled environments (e.g., outside of a freezer or refrigerator), predicted and/or forecasted. environmental conditions through which the product(s) is to be transported (e.g., temperatures, humidity, potential wind, precipitation, etc.), and other such information. The transportation parameters may be obtained based on historic data (e.g., historic weather, historic traffic patterns, data obtained from similar previous deliveries, etc.) and forecasted data (e.g., forecasted weather, forecasted traffic, etc.), current data, and the like. Further, the transportation parameters may be obtained based on information collected by the retail store or chain of stores, and/or one or more third party sources (e.g., one or more weather services, traffic service, delivery service, etc.). Typically, the transportation parameters can further include and/or consider the time, temperature and the like associated with the preparation and/or loading of the product into a cooling system and/or the delivery vehicle, the unloading of the delivery vehicle, and other such factors. The system may take other parameters into consideration including, but not limited to, product parameters (e.g., type of product, size of product, size of multiple products (e.g., sum of volumes and/or volume of strategically arranged products), and the like), customer requests, types of delivery location, whether a temperature control system is available at the delivery location, whether a customer is expected to be available to receive the product(s) at the time of delivery, and other such parameters, and often a combination of two or more of such parameters.

Further, the processes, methods, techniques, circuits, circuitry, systems, devices, functionality, services, servers, sources and the like described herein may be utilized, implemented and/or run on many different types of devices and/or systems. FIG. 2 illustrates an exemplary system 200 that may be used for implementing any of the components, circuits, circuitry, systems, functionality, apparatuses, process, or device of the system 100 of FIG. 1 and/or mentioned above or below, or parts of such circuit, circuitry, functionality, systems, apparatuses, processes, or devices. For example, the system 200 may be used to implement some or all of the product cooling systems 102-104, a temperature control selection system 106, delivery vehicles 108, inventory systems 110, customer profile system 112, delivery control system 114, and/or other such components, circuitry, functionality and/or devices. However, the use of the system 200 or any portion thereof is certainly not required.

By way of example, the system 200 may comprise a control circuit or processor module 212, memory 214, and one or more communication links, paths, buses or the like 218. Some embodiments may include one or more user interfaces 216, and/or one or more internal and/or external power sources or supplies 240. The control circuit 212 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 212 can be part of control circuitry and/or a control system 210, which may be implemented through one or more processors with access to one or more memory 214 that can store code that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 200 may be used to implement one or more of the above or below, or parts of, components, circuits, systems, process and the like. For example, the system may implement the temperature control selection system 106 with the control circuit being a selection system control circuit, product cooling system with the control circuit being a cooling system control circuit, a product delivery control system with the control circuit being a product delivery control circuit, a temperature control system with a temperature control circuit, or other components.

The user interface 216 can allow a user to interact with the system 200 and receive information through the system. In some instances, the user interface 216 includes a display 222 and/or one or more user inputs 224, such as a buttons, touch screen, track ball, keyboard, mouse, etc., which can be part of or wired or wirelessly coupled with the system 200. Typically, the system 200 further includes one or more communication interfaces, ports, transceivers 220 and the like allowing the system 200 to communicate over a communication bus, a distributed computer and/or communication network 120 (e.g., a local area network (LAN), the Internet, wide area network (WAN), etc.), communication link 218, other networks or communication channels with other devices and/or other such communications or combinations thereof. Further the transceiver 220 can be configured for wired, wireless, optical, fiber optical cable, satellite, or other such communication configurations or combinations of two or more of such communications. Some embodiments include one or more input/output (I/O) ports 234 that allow one or more devices to couple with the system 200. The I/O ports can be substantially any relevant port or combinations of ports, such as but not limited to USB, Ethernet, or other such ports.

The system 200 comprises an example of a control and/or processor-based system with the control circuit 212. Again, the control circuit 212 can be implemented through one or more processors, controllers, central processing units, logic, software and the like. Further, in some implementations the control circuit 212 may provide multiprocessor functionality.

The memory 214, which can be accessed by the control circuit 212, typically includes one or more processor readable and/or computer readable media accessed by at least control circuit 212, and can include volatile and/or nonvolatile media, such as RAM, ROM, EEPROM, flash memory and/or other memory technology. Further, the memory 214 is shown as internal to the control system 21.0; however, the memory 214 can be internal, external or a combination of internal and external memory. Similarly, some or all of the memory 214 can be internal, external or a combination of internal and external memory of the control circuit 212. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory. The memory 214 can store code, software, executables, scripts, data, content, lists, programming, programs, log or history data, user information and the like. While FIG. 2 illustrates the various components being coupled together via a bus, it is understood that the various components may actually be coupled to the control circuit and/or one or more other components directly.

Some embodiments include the I/O interface 234 that allows wired and/or wireless communication coupling of to external components, such as with one or more product cooling systems 102-104, temperature control selection system 106, delivery vehicles 108, inventory systems 110, customer profile system 112, delivery control system 114, databases 116, and other such devices or systems. Typically, the I/O interface provides wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some implementations, the system 200 includes one or more sensors 226 that can communicate sensor data to the control circuit 212 and/or other systems. The sensors can include one or more temperature sensors, humidity sensors, inertial sensors, wind speed sensors, acceleration sensors, velocity sensors, weight sensor systems, dimensions sensor systems, product identifying sensor systems (e.g., RFID tag readers, bar code scanners, cameras and text capture systems, etc.), other such sensors, or combination of two or more of such sensors. The sensors may communicate wired or wirelessly over the communication link 218, the distributed computer and/or communication network 120, or the like. Further, the sensors 226 are illustrated directly coupled with the control circuit 212 via the communication link 218; however, one or more sensors may be internal, external or a combination of internal and external, other networks or communication channels with other devices and/or other such communications or combinations thereof. For example, in some applications one or more temperature sensors may be positioned within a product holder or cavity of a cooling system, adjacent to or as part of a product holder, incorporated into insulation, external to a housing of a cooling system, other such locations, or combination of two or more of such locations. Additionally or alternatively, one or more sensors and/or sensor systems may be cooperated with and/or positioned as part of or adjacent to a conveyor system that transports products in preparation for delivery, as part of a transport system (e.g., forklift, pallet jack, etc.), and/or other such systems.

As described above, some embodiments include the temperature control selection system 106 that evaluates multiple parameters to select one or more product temperature control systems, from multiple different types of temperature control systems, to be used while delivering one or more products. The temperature control systems can comprise one or more temperature pack cooling systems with one or more control circuits, evaporative temperature control systems with evaporative control system control circuit, cryogenic substance cooling systems with cryogenic cooling system control circuit, aerosol temperature control systems with aerosol control system control circuit, cooling sustaining bag systems, heat pack temperature systems, other temperature control systems, or combination of two or more of such systems.

In some embodiments, the temperature control selection system 106 directs the utilization of one or more temperature pack cooling systems to limit temperature changes of products during delivery. The temperature pack cooling systems customize the use of temperature packs and insulation to achieve a desired temperature and/or limit temperature changes of products.

A delivery control circuit of the delivery control system 114 is configured to obtain an identification of each product to be transported to a delivery location and that has one or more temperature thresholds that are to be considered and/or maintained in determining a delivery strategy. Transport temperature thresholds are further obtained for each of those products. The transport temperature thresholds corresponds to a temperature below which the corresponding one of the products is to be maintained while being transported to the delivery location. Further, the transport temperature threshold may be specific to a particular product and often varies between products. Additionally, the transport temperature threshold may be limited to while the product is in transit, while one or more other temperature thresholds may be relevant to the product while the product is at a retail facility or other storage location. For example, for some products that are kept cold a transport temperature threshold may be greater than a storage temperature threshold (e.g., ice cream may have a transport temperature threshold that allows a slow melting of the ice cream, while the storage temperature threshold maintains the ice cream in a frozen state). Some transport temperature thresholds may further be associated with a time threshold. For example, some products may have multiple transport temperature thresholds with a first transport temperature threshold being less than a second transport temperature threshold, such that the product can exceed the first temperature threshold for a threshold period of time while remaining below the second temperature threshold.

The product delivery control circuit further obtains expected transport parameters corresponding to the delivery of the products. As described above, the transport parameters can include one or more parameters that are expected to and/or may have an effect on the temperature and temperature changes of products during transport. In some instances, the product delivery control circuit obtains at least a predicted transport duration to transport the multiple products to the delivery location and expected environmental conditions to be encountered during the transport of the multiple products to the delivery location. The duration may be predicted based on historic data (e.g., based on one or more previous deliveries from a delivery location to the intended delivery location or a different delivery location that is within a threshold distance from the intended delivery location, deliveries from other locations to the delivery location or different location within the threshold distance, other deliveries from other locations to the delivery location, historic traffic information, etc.), predicted traffic data, driver's habits, and other such data. Further, the environmental conditions can also be predicted based on forecasted weather, historic data (e.g., historic temperatures relative to a delivery vehicle and/or method of delivery), and the like.

Based on transport parameters and product parameters (e.g., the transport temperature threshold of each of the multiple products), a delivery control systems 114 can determine quantities of insulation to be positioned at each of multiple different insulation locations about the multiple products and number of temperature packs to be positioned at cooling locations about the multiple products to limit temperature change and/or maintain one or more products at a or below a threshold temperature while being delivered. The quantities of insulation and numbers of temperature packs can be determined based in part on historic data relative to previous deliveries of products with similar temperature thresholds, and the changes in temperature detected over time relative to numbers of temperature packs used, quantities of insulation used, placement of products relative to temperature packs and/or insulation and other such information. Further, some embodiments use product rating corresponding to expected rates of change of temperature of products, water content of different products for which temperature change is to be limited, numbers of products to be delivered, temperatures of those other products, temperature thresholds of those products, other such factors, and typically a combination of two or more of such factors.

Additionally, in some embodiments, the product delivery control circuit further selects one or more types of temperature packs to be included. Temperature packs have pack characteristics, and different temperature packs often have different characteristics. For example, temperature packs have minimum and/or maximum temperatures, rates of temperature change (e.g., different melting rate), sizes, shapes, and other such characteristics. The temperature packs may contain water, salt water, glycols, oils, ammonia, endothermic reactive compounds, exothermic reactive compounds, a coolant having a freezing point of less than 0° C., other such compounds, or combinations of such compounds. The product delivery control circuit 212 can take these characteristics into consideration and/or the relationships and/or effects of such characteristics on other types of temperature packs in selecting the number and/or type of temperature packs to be used. Similarly, the insulations have insulation characteristics, and different insulations can have different insulation characteristics. For example insulation characteristics can include but are not limited to insulation rating or thermal resistance rating, thickness, size, shape, compressibility factor, rigidity factor, and other such characteristics. These characteristics can also be considered and are typically considered in relation to the pack characteristics, product transport temperature thresholds, transport parameters, predicted environmental conditions, other such factors, or combinations of two or more of such factors. Some embodiments, for example, consider at least in part the additional size and/or weight that the insulation and/or temperature packs add to a total size of the collection of products in determining quantities of insulation and/or temperature packs to utilize. One or more size and/or weight thresholds may be considered relative to the additional of insulation and/or temperature packs, and/or whether one or more other products from the collection should be removed from the collection to ensure a desired rate of change of temperature of the products having temperature thresholds that are to be maintained during the delivery.

In some embodiments, the delivery control circuit further determines an ordered arrangement of each of the multiple products relative to the temperature threshold of each of the multiple products, the insulation locations and the cooling locations where the temperature packs are placed. The organization of products, in some instances, attempts to establish one or more temperature zones into which products can be placed based at least in part on their transport temperature thresholds. For example, in many applications, products with the lowest transport temperature thresholds are placed into a zone that is predicted to have the lowest temperature, which often corresponds to being closest to temperature packs and/or a largest number of temperature packs, and a thickest quantity of insulation. As a further example, in some embodiments the product delivery control circuit in determining the ordered arrangement of the multiple products identifies a first set of one or more products with a lowest level of temperature thresholds. The ordered arrangement can specify that the first set of products are to be placed in a first zone having a greatest insulation and greatest number of temperature packs. Further, as introduced above, the product delivery control circuit obtains, for each of the multiple products, a rate of temperature change relative to expected environmental conditions, and determines quantities of insulation and/or number of temperature packs to be used, and in determining an arrangement of products.

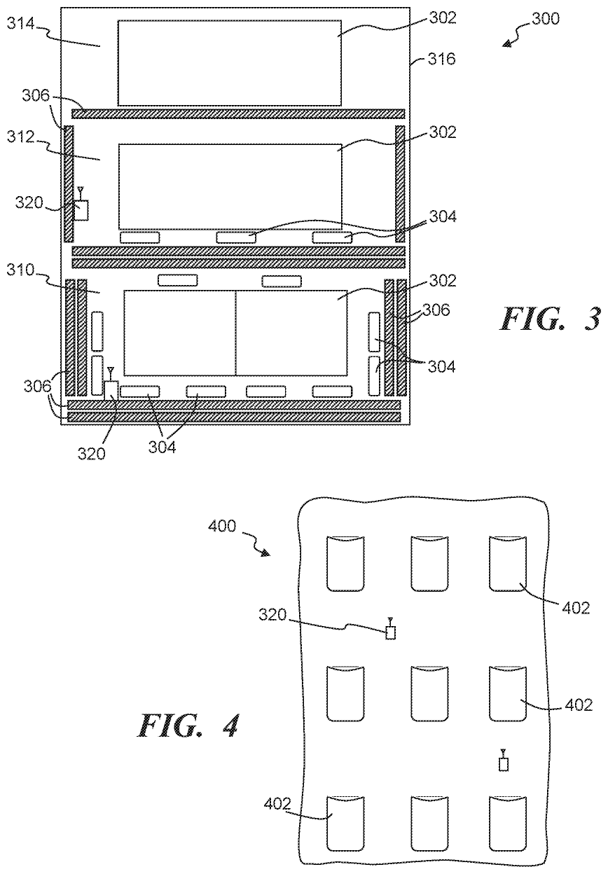

FIG. 3 illustrates a simplified block diagram cross-sectional view of a series of products 302 arranged with a number of exemplary temperature packs 304 and quantities of exemplary insulation 306 of an exemplary temperature pack cooling system 300, in accordance with some embodiments. The products are arranged with a number of temperature packs 304 positioned at cooling locations about the products, and the quantities of insulation 306 are positioned about the products and temperature packs at insulation locations to provide limit temperature changes of products and/or provide temperature control of the products. The system 300 is described as a cooling system. Similar configurations can be used for a temperature pack heating system that can limit temperature changes of heated products. As described above, the arrangement of the products relative to the temperature packs 304 and the insulation 306 is determined at least in part based on temperature thresholds, and the number of temperature packs and quantities of insulation and their positioning is based at least on the temperature thresholds and transport parameters.

Some embodiments utilize a housing 316 into which the products 302, temperature packs 304 and insulation 306 is placed. A lid can be included to close an interior of the housing. The housing may be made from a rigid material (e.g., plastic, wood, metal, other such material, or combination of two or more of such materials), while in other instances, may be made from a flexible insulated material. Further, in some applications the housing allows multiple housings to be stacked and/or cooperated during transport. For example, the housing may define a tote or other reusable container that can be used to organize products for delivery (e.g., one or more totes associated with a single delivery location). The housing may, in some applications, include at least some of the insulation.

In other embodiments, the products are not placed in a housing, and instead the products, insulation and temperature packs can be cooperated together through other methods, such as but not limited to being wrapped with a plastic wrap, straps, netting or the like. Some of the products may, in some instances, be placed on a base or other support structure, while in other instances, the insulation may operate as a base. For example, in some applications, the products are arranged with defined insulation and temperature packs placed adjacent the one or more products as defined according to a determined product arrangement, with plastic wrap wrapped about the collection of products, insulation and temperature packs.

In some embodiments, when multiple products are being transported, these multiple products often have different temperature thresholds. Accordingly, in some embodiments, the product delivery control circuit 212 can define the arrangement of products, insulation and temperature packs into multiple different temperature zones. The product delivery control circuit, in determining the ordered arrangement, can identify a first set of one or more products with a lowest level of temperature thresholds and specify the ordered arrangement such that the first set of products are to be placed in a first zone 310 having a greatest insulation 306 and greatest number of temperature packs 304. The number, types, sizes and/or shapes of temperature packs and/or insulation is dependent on the parameters of the relative temperature packs (e.g., minimum/maximum temperature, rate of change of temperature, weight, etc.) and insulation (insulation rating, weight, etc.), the size and/or shape of the one or more products, etc.

In some embodiments, the product delivery control circuit may identify a second set of one or more products with a second level of temperature thresholds that is greater than the lowest level, and specify the ordered arrangement such that the second set of products are to be placed in a second zone 312 that is separated from the first zone 310 by at least some of the insulation 306. A determined number of temperature packs 304 can be selected for the second zone based at least in part on the temperature thresholds of one or more of the products of the second set of products, and typically additionally based on transport parameters and the expected rate of change of temperature of the product with an initial starting temperature of the one or more products and the quantity of temperature packs, and the insulation rating and/or rate of change of temperature associated with the quantities of insulation and/or other products of the collection. Some embodiments further consider the temperature control effects of the first temperature zone on the second temperature zone. In some instances, the temperature packs used in the second zone may be the same type and/or size as the temperature packs in the first zone 310. In other instances, however, different kinds and/or sizes may be used. Typically, the second zone includes fewer temperature packs than the first zone, at least when the temperature packs are the same as those used in the first zone. In some instances, when the same type, thickness and/or size of insulation is used in both the first and second zones, the quantity of insulation used in the second zone is less in the second zone.

Further, in some implementations, the product delivery control circuit may identify one or more other sets of one or more products. For example, a third set of one or more products may be identified that have a third level of temperature thresholds and/or do not have a temperature threshold. The ordered arrangement of the products can be specified with the third set of products ordered to be placed in a third zone 314 that is separated from the second zone by at least some of the insulation, is separated from the first zone 310 by additional insulation, and in some instances is further separated from the first zone 310 by at least the second zone 312. Other zones can be defined for other products with other temperature thresholds and/or that do not have temperature thresholds. Similarly, the type of insulation used in the second zone and/or third zone may be the same or different than the insulation used in the first zone and/or second zone.

The temperature packs 302 and the insulation 306 are illustrated in FIG. 3 as separate. In some embodiments, however, the temperature packs can be cooperated with the insulation, and/or formed as part of or within the insulation. In some instances, the product delivery control circuit may select insulation that is cooperated with or can be cooperated with temperature packs over insulation that is separate from temperature packs, or may use a combination of insulation that is cooperated with temperature packs, insulation that is separate from temperature packs and/or separate temperature packs. Further, in some implementations, one or more insulations 306 may be a flexible membrane insulator that can be draped, wrapped, or otherwise positioned about, under, and/or on products.

In some embodiments, one or more sensors 320 may be positioned in one or more of the zones. The sensors may include one or more temperature sensors, humidity sensors, location sensors, other such sensors, or combination of such sensors. The sensors may locally store sensor information and communicate (wired or wirelessly) the information when in range of one or more control systems, such as the delivery control system 114, a delivery vehicle control system, or other such system. The sensor data may be used as historic data in subsequently selecting quantities of insulation and/or numbers of temperature packs. Additionally or alternatively, when one or more temperature packs can be activated, such as through the activation of a chemical reaction, a local control circuit may receive the temperature data and activate one or more of the temperature packs when one or more thresholds are reached. The sensors may be standalone sensors that can be placed adjacent a product. In some instances, the sensors may additionally or alternatively be part of or secured with one or more insulation, temperature pack, and/or the housing 316.

FIG. 4 illustrates a simplified block diagram plane view of an exemplary flexible membrane insulator 400, in accordance with some embodiments, that can be used as an insulator 306 as part of a temperature pack cooling system 300. The flexible membrane insulator 400, in some implementations, includes multiple pockets 402, pouches, or other such structures to receive one or more temperature packs. In some instances, the temperature packs may be permanently affixed within the pockets, while in other instances, the temperature packs may be removable. One or more methods may be provide to maintain the removable temperature packs within the pockets (e.g., Velcro overhang, Velcro strap(s), flap(s), snap(s), button(s), Velcro on the temperature pack, etc.). In some embodiments, the flexible membrane insulator includes one or more sensors 320 (e.g., temperature sensor, humidity sensor, etc.).

The flexible membrane insulator can include one or more layers of insulating material (e.g., wool, polar fleece, cotton, polyester, feather down, canvas, plastic, aluminum, etc.), and often a combination of such materials. For example, a flexible membrane insulator may comprise a canvas and/or plastic outer layer, with one or more insulating inner layers of polar fleece. In some embodiments, the flexible membrane insulation is formed as a blanket, strip, or substantially any relevant shape with substantially any relevant size depending on an intended implementation. For example, the flexible membrane insulation may be shaped to wrap around a particular volume (in application may include one or more products) multiple times. One or more straps, Velcro strips and/or other such mechanisms can be fixed with the flexible membrane insulator to help maintain a positioning of flexible membrane insulator when used.

In some implementations, one or more flexible membrane insulators can be wrapped about one or more products. This allows the flexible membrane insulators to be used with a single product or multiple products, and in some instances maintains the temperature packs adjacent the one or more products. Further, multiple flexible membrane insulators can be utilized in adjacent layers and/or layers separated by products and/or additional insulation. In stacking the flexible membrane insulators, each of the flexible membrane insulators may include temperature packs, while in other implementations, one or more of the stacked flexible membrane insulators may not include temperature packs.

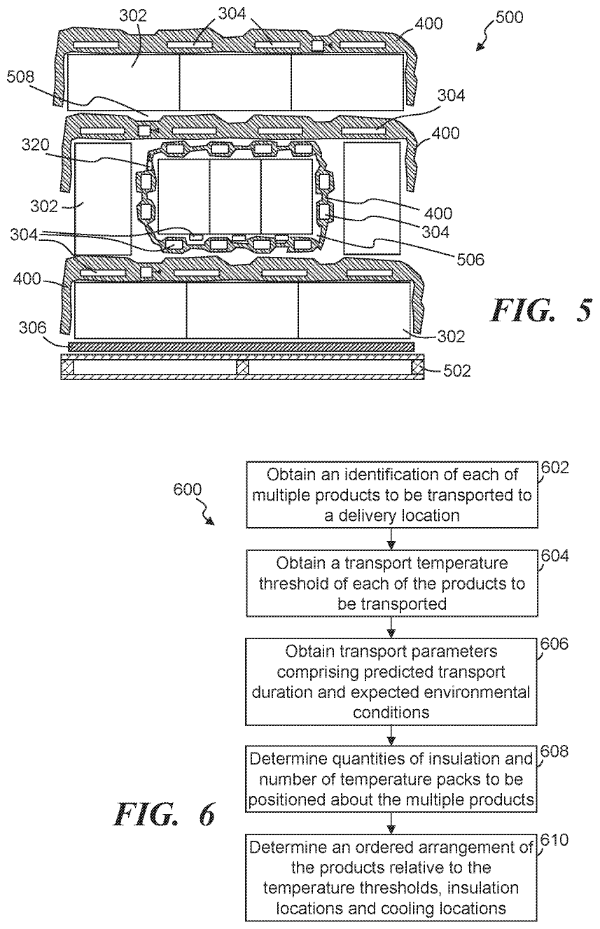

FIG. 5 illustrates a simplified block diagram cross-sectional view of a series of products 302 arranged with a number of exemplary temperature packs 304 and cooperated with one of multiple flexible membrane insulators 400 providing an exemplary temperature pack cooling system 500, in accordance with some embodiments. The quantity of flexible membrane insulators are positioned about the products at insulation locations. For example, the flexible membrane insulators can be wrapped about one or more products, draped over one or more products, positioned between products (e.g., providing temperature control and padding), positioned in other implementations, or combinations of two or more of such placements. Further, the flexible membrane insulators can be used in stacked configurations.

In some embodiments, the flexible membrane insulators can be used with a set of products, and/or larger sets of products. This can include utilizing one or more flexible membrane insulators with pallets of products. Products 302 can be positioned on a base 502 (e.g., a pallet, plate, etc.) with one or more flexible membrane insulators 400 positioned on, around and/or under one or more of the products. In some instances, one or more flexible membrane insulators 400 may be wrapped one or more times around one or more products and/or the pallet of products. The flexible membrane insulators can further be used to establish different temperature zones.

The product delivery control circuit, in some embodiments, may receive a notification that multiple products are intended to be arranged on a base or pallet 502 and intended to be transported as a collection or pallet of products. Based on this information the product delivery control circuit can select one or more flexible membrane insulator 400 and/or other insulators to be used in arranging the products as the pallet of products. The flexible membrane insulators may be the only insulation used in some instances, and/or may be used in addition with one or more other insulations 306 in other instances. For example, one or more relatively planar insulations 306 may be used relative to the pallet 502 and/or as a foundation with products 302 stacked on the foundation insulations. Further, the arrangement of products and insulation may establish one or more temperature zones for different sets of products having different temperature thresholds. In some embodiments, the product delivery control circuit may define a first zone 506 at an interior of the arranged products with one or more temperature packs 304 and/or one or more flexible membrane insulators 400 having multiple temperature packs 304 positioned in a selected number of pockets (or one of multiple different flexible membrane insulators having predefined numbers of temperate packs at predefined locations can be selected) intended to be wrapped about a first set of one or more products. Additional products corresponding to a second zone 508 can be arranged adjacent to one or more sides of the first zone. One or more other zones may be specified on the pallet of products. In some embodiments, the product delivery control circuit further takes into consideration the insulating effects or insulating ratings corresponding to one or more products and packaging (when relevant) and/or their temperatures and rates of change of temperature in determining a quantity of insulation and temperature packs to be used with the collection and/or pallet of products.

The product delivery control circuit can provide arrangement and/or stacking instructions to one or more workers defining how the workers are to arrange the products and the insulation, and in some instances the temperature packs (e.g., when the temperature packs are separate from and/or can be separated from the insulation). For example, when the product delivery control circuit determines than one or more flexible membrane insulators are to be used, instructions can be provided instructing that the selected one or more flexible membrane insulators be positioned relative to one or more products, such as wrapped about at least a first set of products and positioned on the pallet as part of assembling of the multiple products on the pallet. The assembly instructions can further direct the placement of one or more additional temperature packs, insulations and/or flexible membrane insulators (e.g., placed over different layers of products. The assembly instructions can be provided as a print out, communicated to a portable user electronic device (e.g., smart phone, tablet, custom retail store device, etc.). Further, the instructions may provide images illustrating the orientation and arrangement of different packages and/or products.

In some embodiments, the temperature control selection system considers a type or method of transport and delivery in selecting the temperature pack control system as a primary or secondary system of limiting temperature change. For example, the method of transport may be through one or more methods such as, but not limited to, a delivery truck, a delivery van, a delivery car, an unmanned ground or land-based vehicle (UGV), an unmanned aircraft system (UAS), other such delivery methods, or combination of such delivery methods. Some temperature control systems may not be suitable for some of the delivery methods, some temperature control systems may be more effective with some methods of delivery, and/or some temperature control systems may be more readily implemented with some delivery methods. Accordingly, the temperature control selection system may identify a selected and/or scheduled method of transport of the multiple products by the delivery vehicle to the delivery location, and select from multiple different types of temperature control systems a temperature pack cooling system, with use of the temperature packs and the corresponding quantities of insulation, as a function of the method of transport. For example, the multiple products may be intended to be delivered by a delivery truck, unmanned ground vehicle, or other such delivery methods that can readily carry multiple products and/or heavier loads than other types of delivery methods (e.g., UAS), and some embodiments may select the temperature pack cooling system to limit changes in temperature of products based on the ground delivery. Further, in some implementations, the temperature control selection system may select two or more of the temperature control systems to be cooperatively utilized during the delivery, and/or one to be used as a primary cooling system with one or more to be utilized as secondary cooling method and/or backup cooling method. Further, multiple methods of delivery may be used (e.g., delivery truck and a UAS). Accordingly, multiple temperature control systems may be selected based on the multiple methods of delivery. Other cooling systems are described in U.S. Application Nos. 62/338,231 filed May 18, 2016 entitled CRYOGENIC COOLING SYSTEMS AND METHODS OF CONTROLLING PRODUCT TEMPERATURES DURING DELIVERY (137873); 62/338,224 filed May 18, 2016 entitled EVAPORATIVE COOLING SYSTEMS AND METHODS OF CONTROLLING PRODUCT TEMPERATURES DURING DELIVERY (137875); 62/338,290 filed May 18, 2016 entitled SYSTEMS AND METHODS OF CONTROLLING PRODUCT TEMPERATURES DURING DELIVERY (137876); 62/345,443 filed Jun. 3, 2016 entitled TEMPERATURE CONTROL SYSTEMS USING TEMPERATURE SUSTAINING BAGS AND METHODS OF CONTROLLING PRODUCT TEMPERATURES DURING DELIVERY (138251); 62/403,909 filed Oct. 4, 2016 entitled SYSTEMS AND METHODS UTILIZING NANOTECHNOLOGY INSULATION MATERIALS IN LIMITING TEMPERATURE CHANGES DURING PRODUCT DELIVERY (137874); 62/350,515 filed Jun. 16, 2016 entitled SYSTEMS AND METHODS OF CONTROLLING PRODUCT TEMPERATURES DURING DELIVERY (138259); and 62/367,376 filed Jul. 27, 2016 entitled SYSTEMS AND METHODS FOR DELIVERING PERISHABLE ITEMS (138262); all of which are incorporated herein by reference in their entirety.

In some embodiments, size and weight data is obtained for each of the multiple products. The weight data may be received from one or more weight sensing systems may be included in the system 100 and coupled with the temperature control selection system and/or the product cooling system. Similarly, one or more dimensions and/or distance measurement systems may be included in the system 100 and coupled with the temperature control selection system and/or the product cooling system, and providing size data to be used in selecting the temperature pack cooling system (e.g., size is greater than a threshold of one or more other temperature control systems and/or delivery methods, weight is greater than a threshold of one or more other temperature control systems and/or delivery methods, etc.), and/or in selecting types and/or quantities of cooling packs and/or insulation. These factors can be considered in selecting a temperature control system from multiple different types of temperature control systems. The product delivery control circuit and/or temperature control selection system can select the temperature pack cooling system, with use of the temperature packs and the corresponding quantities of insulation, as a function of a total weight and estimated total size of a collection of the multiple products. Additionally or alternatively, the temperature pack cooling system may be selected based in part on a duration of time it is expected to delivery products. For example, the temperature pack cooling system may be utilized with some deliveries having longer delivery times, over some other cooling systems. For example, the size and/or weight may exceed thresholds of some or all of the other available temperature control systems. Similarly, the system may identify that additional products are to be delivered to the same location that would exceed thresholds of one or more other delivery methods, and the temperature of the one or more temperature thresholds can be maintained based on a rate of temperature change of one or more temperature packs relative to the expected exposed temperature during the expected duration of delivery. Further, one or more databases on insulation characteristics (e.g., material's resistance to conductive heat flow measured or rated in terms of its thermal resistance or R-value) of one or more other products to be cooperated with the products having temperature thresholds can be considered in addition to insulation characteristics. In some embodiments, the insulating rating of multiple products and/or insulation between a product and an exterior temperature environment in a given direction may be summed to determine an estimated total insulation rating in that given direction, which corresponds to an estimated rate in change of temperature relative to the expected environmental conditions during delivery. Using the temperature of the one or more products, and the temperature of the temperature packs, in addition to the rates of change of temperature of the one or more products and the temperature packs, the system can estimate a number of temperature packs and insulation to include to achieve desired rate of change of temperature, based on expected environmental conditions and duration of delivery. In some embodiments, the rate of change of temperature is calculated based on a formula for each flow (e.g., ΔQ/Δt=−K×A×ΔT/x, where ΔQ/Δt is the rate of heat flow; −K is the thermal conductivity factor; A is the surface area; ΔT is the change in temperature and x is the thickness of the material).

FIG. 6 illustrates a simplified flow diagram of an exemplary process 600 of limiting temperature changes of a product during transit, in accordance with some embodiments. In step 602, an identification is obtained for each of multiple products to be transported to a delivery location by a delivery vehicle. In some instances, the inventory system and/or an order system provides the identification of products that are to be delivered to one or more customers and/or to a shopping facility, with one or more of those products having one or more temperature thresholds.

In step 604, a transport temperature threshold is obtained for each of the multiple products to be transported to a delivery location by a delivery vehicle. Again, one or more temperature thresholds (and in some instances corresponding duration thresholds) may be associated with a product. The temperature threshold may be a minimum temperature, a maximum temperature, a desired transport temperature, a temperature associated with a corresponding duration of time, or the like. In some instances, the transport temperature threshold defines a temperature below which the corresponding one of the multiple products is to be maintained while being transported to the delivery location.

In step 606, transport parameters are obtained relative to the delivery location and/or the route between a distribution location and the delivery location. In some instances, the transport parameters comprise a predicted transport duration to transport the multiple products to the delivery location and expected environmental conditions to be encountered during the transport of the multiple products to the delivery location. In step 608, quantities of insulation are determined that are to be positioned at each of multiple different insulation locations about the multiple products and a number of temperature packs are determined that are to be positioned at cooling locations about the multiple products. In some embodiments, the quantities of insulation and number of temperature packs are determined based at least in part on the transport parameters and temperature threshold of each of the multiple products. In step 610, an ordered arrangement is determined for each of the multiple products relative to the temperature threshold of each of the multiple products, the insulation locations and the cooling locations.

Some embodiments, in determining the ordered arrangement of the multiple products, identifies a first set of one or more products with a lowest level of temperature thresholds and specifies the ordered arrangement such that the first set of products are to be placed in a first zone having a greatest insulation and greatest number of temperature packs. Further, some embodiments identify a second set of one or more products with a second level of temperature thresholds that is greater than the lowest level, and specifies the ordered arrangement such that the second set of products are to be placed in a second zone that is separated from the first zone by at least some of the insulation. In some implementations, a third set of one or more products can be identified that have a third temperature threshold or do not have a temperature threshold. The ordered arrangement can specify that the third set of products are to be placed in a third zone that is separated from the second zone by at least some of the insulation, and in some instance may further be separated from the first zone by at least the second zone.

In some embodiments, a notification is received specifying that the multiple products are intended to be arranged on a pallet and transported as a pallet of products. One or more of the insulation selected can include one or more flexible membrane insulators 400 that each comprise a flexible membrane having multiple pockets each configured to receive a temperature pack. The flexible membrane insulators can, in some applications, be wrapped about one or more products. Instructions can be provided instructing that the selected flexible membrane insulators are to be wrapped about at least the first set of products and positioned on the pallet as part of assembling of the multiple products on the pallet.

In determining the quantities of insulation and number of temperature packs, some embodiments obtain, for each of the multiple products, a rate of temperature change relative to expected environmental conditions. Some embodiments, in selecting the temperature pack cooling system, identify a method of transporting the multiple products by the delivery vehicle to the delivery location, and select the temperature pack cooling system from multiple different types of temperature control systems as a function of the method of transport. Size and/or weight data can obtaining for each of the multiple products. Some embodiments select from multiple different types of temperature control systems a temperature pack cooling system, with use of the temperature packs and the corresponding quantities of insulation, as a function of a total weight and estimated total size of a collection of the multiple products.

In some embodiments, systems, apparatuses, methods, and process are provided to limit temperature changes of products during transit, comprising: a plurality of insulation; a plurality of temperature packs; a product delivery control circuit; and a memory coupled to the product delivery control circuit and storing computer instructions that when executed by the product delivery control circuit cause the product delivery control circuit to: obtain an identification of each of multiple products to be transported to a delivery location by a delivery vehicle; obtain, for each of the multiple products, a transport temperature threshold below which the corresponding one of the multiple products is to be maintained while being transported to the delivery location; obtain transport parameters comprising a predicted transport duration to transport the multiple products to the delivery location and expected environmental conditions to be encountered during the transport of the multiple products to the delivery location; determine, based on the transport parameters and temperature threshold of each of the multiple products, quantities of insulation to be positioned at each of multiple different insulation locations about the multiple products and number of temperature packs to be positioned at cooling locations about the multiple products; and determine an ordered arrangement of each of the multiple products relative to the temperature threshold of each of the multiple products, the insulation locations and the cooling locations.

Some embodiments provide methods of limiting temperature changes of a product during transit, comprising: obtaining an identification of each of multiple products to be transported to a delivery location by a delivery vehicle; obtaining, for each of the multiple products, a transport temperature threshold below which the corresponding one of the multiple products is to be maintained while being transported to the delivery location; obtaining transport parameters comprising a predicted transport duration to transport the multiple products to the delivery location and expected environmental conditions to be encountered during the transport of the multiple products to the delivery location; determining, based on the transport parameters and temperature threshold of each of the multiple products, quantities of insulation to be positioned at each of multiple different insulation locations about the multiple products and number of temperature packs to be positioned at cooling locations about the multiple products; and determining an ordered arrangement of each of the multiple products relative to the temperature threshold of each of the multiple products, the insulation locations and the cooling locations.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A system to limit temperature changes of products during transit, comprising:
a plurality of insulation;
a plurality of temperature packs;
a product delivery control circuit; and
a memory coupled to the product delivery control circuit and storing computer instructions that when executed by the product delivery control circuit cause the product delivery control circuit to:
obtain an identification of each of multiple products to be transported to a delivery location by a delivery vehicle;
obtain, for each of the multiple products, a transport temperature threshold below which the corresponding one of the multiple products is to be maintained while being transported to the delivery location;
obtain transport parameters comprising a predicted transport duration to transport the multiple products to the delivery location and expected environmental conditions to be encountered during the transport of the multiple products to the delivery location;
determine, based on the transport parameters and temperature threshold of each of the multiple products, quantities of insulation to be positioned at each of multiple different insulation locations about the multiple products and number of temperature packs to be positioned at cooling locations about the multiple products; and
determine an ordered arrangement of each of the multiple products relative to the temperature threshold of each of the multiple products, the insulation locations and the cooling locations.

2. The system of claim 1, wherein the product delivery control circuit in determining the ordered arrangement of the multiple products is configured to identify a first set of one or more products with a lowest level of temperature thresholds and specify the ordered arrangement such that the first set of products are to be placed in a first zone having a greatest insulation and greatest number of temperature packs.

3. The system of claim 2, wherein the product delivery control circuit in determining the ordered arrangement of the multiple products is configured to identify a second set of one or more products with a second level of temperature thresholds that is greater than the lowest level, and specify the ordered arrangement such that the second set of products are to be placed in a second zone that is separated from the first zone by at least some of the insulation.

4. The system of claim 3, wherein the product delivery control circuit in determining the ordered arrangement of the multiple products is configured to identify a third set of one or more products that do not have a temperature threshold, and specify the ordered arrangement such that the third set of products are to be placed in a third zone that is separated from the first zone by at least the second zone and separated from the second zone by at least some of the insulation.

5. The system of claim 2, wherein at least some of the plurality of insulators comprises flexible membrane insulators each comprising a flexible membrane having multiple pockets each configured to receive a temperature pack, wherein the flexible membrane insulators are configured to be wrapped about one or more products; and
wherein the product delivery control circuit is configured to:
receive a notification that the multiple products are intended to be arranged on a pallet and transported as a pallet of products;
select at least one flexible membrane insulator; and
instruct that the selected at least one flexible membrane insulator is to be wrapped about at least the first set of products and positioned on the pallet as part of assembling of the multiple products on the pallet.

6. The system of claim 1, wherein the product delivery control circuit in determining the quantities of insulation and number of temperature packs is configured to obtain, for each of the multiple products, a rate of temperature change relative to expected environmental conditions.

7. The system of claim 1, wherein the product delivery control circuit is further configured to:
identify a method of transport of the multiple products by the delivery vehicle to the delivery location; and
select from multiple different types of temperature control systems a temperature pack cooling system, with use of the temperature packs and the corresponding quantities of insulation, as a function of the method of transport.

8. The system of claim 1, wherein the product delivery control circuit is further configured to:
obtain, for each of the multiple products, size and weight data;
select from multiple different types of temperature control systems the temperature pack cooling system, with use of the temperature packs and the corresponding quantities of insulation, as a function of a total weight and estimated total size of a collection of the multiple products.

9. A method of limiting temperature changes of a product during transit, comprising:
obtaining an identification of each of multiple products to be transported to a delivery location by a delivery vehicle;
obtaining, for each of the multiple products, a transport temperature threshold below which the corresponding one of the multiple products is to be maintained while being transported to the delivery location;
obtaining transport parameters comprising a predicted transport duration to transport the multiple products to the delivery location and expected environmental conditions to be encountered during the transport of the multiple products to the delivery location;
determining, based on the transport parameters and temperature threshold of each of the multiple products, quantities of insulation to be positioned at each of multiple different insulation locations about the multiple products and number of temperature packs to be positioned at cooling locations about the multiple products; and
determining an ordered arrangement of each of the multiple products relative to the temperature threshold of each of the multiple products, the insulation locations and the cooling locations.

10. The method of claim 9, wherein the determining the ordered arrangement of the multiple products comprises identifying a first set of one or more products with a lowest level of temperature thresholds and specifying the ordered arrangement such that the first set of products are to be placed in a first zone having a greatest insulation and greatest number of temperature packs.

11. The method of claim 10, wherein the determining the ordered arrangement of the multiple products comprises identifying a second set of one or more products with a second level of temperature thresholds that is greater than the lowest level, and specifying the ordered arrangement such that the second set of products are to be placed in a second zone that is separated from the first zone by at least some of the insulation.

12. The method of claim 11, wherein the determining the ordered arrangement of the multiple products comprises identifying a third set of one or more products that do not have a temperature threshold, and specifying the ordered arrangement such that the third set of products are to be placed in a third zone that is separated from the first zone by at least the second zone and separated from the second zone by at least some of the insulation.

13. The method of claim 10, further comprising:
receiving a notification that the multiple products are intended to be arranged on a pallet and transported as a pallet of products;
selecting at least some of the insulation to include flexible membrane insulators each comprising a flexible membrane having multiple pockets each configured to receive a temperature pack, wherein the flexible membrane insulators are configured to be wrapped about one or more products; and
instructing that the selected flexible membrane insulators are to be wrapped about at least the first set of products and positioned on the pallet as part of assembling of the multiple products on the pallet.

14. The method of claim 9, wherein the determining the quantities of insulation and number of temperature packs further comprises obtaining, for each of the multiple products, a rate of temperature change relative to expected environmental conditions.

15. The method of claim 9, further comprising:
identifying a method of transport of the multiple products by the delivery vehicle to the delivery location; and
selecting from multiple different types of temperature control systems a temperature pack cooling system, with use of the temperature packs and the corresponding quantities of insulation, as a function of the method of transport.

16. The method of claim 9, further comprising:
obtaining, for each of the multiple products, size and weight data;
selecting from multiple different types of temperature control systems a temperature pack cooling system, with use of the temperature packs and the corresponding quantities of insulation, as a function of a total weight and estimated total size of a collection of the multiple products.
